(19) United States
(12) Patent Application Publication
(10) Pub. No.: US 2016/0355665 A1
(43) Pub. Date: Dec. 8, 2016

(54) ESTER PLASTICIZERS BASED ON RENEWABLE RAW MATERIALS FOR ELASTOMERS

(71) Applicant: AMRIL AG, Zug (CH)

(72) Inventors: Peter DAUTE, Beverstedt (DE); Sascha SIMON, Bremerhaven (DE); Marcel KOCH, Oldenburg (DE)

(21) Appl. No.: 15/027,934

(22) PCT Filed: Feb. 13, 2015
(86) PCT No.: PCT/EP2015/053152

§ 371 Date: Apr. 7, 2016

(51) Int. Cl. C08K 5/101; C08K 3/04

(52) U.S. Cl. CPC C08K 5/101; C08K 3/04

(57) ABSTRACT

The present invention relates to a composition comprising (a) an ester obtainable by reacting an unsaturated branched or saturated branched C8-C28 alcohol with an unsaturated linear or saturated linear C12-C22 fatty acid, and (b) an elastomer. Further aspects of the invention include the use of an ester as defined in (a) as plasticizer in an elastomer.

The present invention relates to a composition comprising (a) an ester obtainable by reacting an unsaturated branched or saturated branched C8-C28 alcohol with an unsaturated linear or saturated linear C12-C22 fatty acid, and (b) an elastomer. Further aspects of the invention include the use of an ester as defined in (a) as plasticizer in an elastomer.

### BACKGROUND OF THE INVENTION

Plasticizers are additives that increase the flexibility, pliability, and plasticity or malleability of a material. One application is the addition to an elastomer in particular in order to change the mechanical properties of the elastomer. For example, in order to increase the wear and abrasion resistance of rubber tires, plasticizers can be added to the rubber composition.

If a plasticizer is added it is preferred that it will also contribute to the mechanical properties of the elastomer after vulcanization.

Typically, naphthenic or paraffinic mineral oils are added to the elastomer (see e.g. Handbuch der Kautschuktechnologie, Dr. Gupta Verlag, 2001, chapter 5, page 37). Also aromatic plasticizers are known for use with elastomers.

Plasticizers can, thus, offer the formulator several advantages including easier rubber processing, improved mechanical performance and also improved properties at low temperatures.

However, there is a general need to make elastomer compositions more environmentally friendly.

### SUMMARY OF THE INVENTION

It was unexpectedly found that certain esters in particular when based on renewable raw materials give excellent plasticizing properties for elastomers such as EPDM. Similar results are expected for other elastomers including for example SBR, BR, NBR, FKM, HNBR and NR. The plasticizer according to the invention is an ester that can be obtained from renewable resources and/or include esters from linear saturated fatty acids with C6 to C22 and saturated branched alcohols with C4 to C22. Since these esters can be based on renewable raw materials even up to 100%, they are more environmentally friendly than prior art plasticizers.

The present invention therefore provides in a first aspect a composition comprising
(a) an ester obtainable by reacting
   (i) an unsaturated branched or saturated branched C8-C28 alcohol; with
   (ii) an unsaturated linear or saturated linear C12-C22 fatty acid; and
(b) an elastomer.

A further aspect of the invention relates to the use of an ester of the invention as plasticizer in an elastomer.

### DETAILED DESCRIPTION OF THE INVENTION

Before the present invention is described in detail below, it is to be understood that this invention is not limited to the particular methodology, protocols and reagents described herein as these may vary. It is also to be understood that the terminology used herein is for the purpose of describing particular embodiments only, and is not intended to limit the scope of the present invention which will be limited only by the appended claims. Unless defined otherwise, all technical and scientific terms used herein have the same meanings as commonly understood by one of ordinary skill in the art.

As used herein the term “fatty acid” refers to an aliphatic monocarboxylic acid. The term “fatty acid” can include also mixtures of fatty acids selected from fatty acids within the respectively indicated carbon number range.

As used herein the term “alcohol” can include also mixtures of alcohols selected from alcohols within the respectively indicated carbon number range.

In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Some documents are cited throughout the text of this specification. Each of the documents cited herein, whether supra or infra, is hereby incorporated by reference in its entirety. Nothing herein is to be construed as an admission that the invention is not entitled to antedate such disclosure by virtue of prior invention.

One advantage of the invention is the universal utility of the ester of the invention as plasticizer also because of its rather non-polar character. Thus, the ester can be used for several synthetic and natural elastomers. Until now these esters have not been used as plasticizers for elastomers.

Accordingly, as a first aspect the invention provides a composition comprising
(a) an ester (preferably a monoester) obtainable by reacting
   (i) an unsaturated branched or saturated branched C8-C28 aliphatic alcohol; with
   (ii) an unsaturated linear or saturated linear C12-C22 fatty acid;
and
(b) an elastomer.

Preferably, said alcohol in (i) is a saturated branched C12-C24 alcohol, i.e. the alcohol may be a saturated branched C10, C11, C12, C13, C14, C15, C16, C17, C18, C19, C20, C21, C22, C23 or a saturated branched C24 alcohol or a mixture of two or more of the aforementioned saturated branched alcohols.

In a more preferred embodiment of the composition the alcohol in (i) is a saturated branched C13-C20 alcohol, i.e. a saturated branched C13, C14, C15, C16, C17, C18, C19 or C20 alcohol or a mixture of two or all of the aforementioned saturated branched alcohols.

Preferably, the alcohol is a primary or secondary monool. More preferably, said alcohol is a primary saturated branched C18-C22 monool.

In a further preferred embodiment the alcohol is a saturated branched C10, C13 and/or C20 alcohol and preferably a saturated branched C10, C13 and/or C20 monool.

Most preferably the aliphatic alcohol in (a) is 2-propylheptanol, 2-octyl-1-dodecanol or iso-tridecyl alcohol.

It is further preferred that in the composition according to the invention the fatty acid in (ii) is a linear saturated C12-C22 fatty acid, and preferably a linear saturated C12-C22 fatty acid, i.e. a C12, C13, C14, C15, C16, C17, C18, C19, C20, C21 or C22 fatty acid or a mixture thereof. More preferably, the fatty acid is a C16 and/or C 18 fatty acid and most preferably the fatty acid is stearic acid and/or palmitic acid.

Also the combination of the aforementioned linear saturated fatty acids and the aforementioned saturated branched alcohols (and preferable monools) is preferred as the basis for the ester of the invention.

In a preferred embodiment, the ester comprised in the composition as component (a) is a monoester.

In a further preferred embodiment the composition of the invention comprises
(a) a monoester obtainable by reacting
   (i) a saturated branched C13-C20 (C 13, C14, C15, C16, C17, C18, C19 or C20 or a mixture thereof) aliphatic alcohol; with
   (ii) an unsaturated linear or saturated linear C12-C22 fatty acid; and preferably a an unsaturated linear or saturated linear C16-C18 fatty acid;
and
(b) an elastomer.

In a most preferred embodiment the monoester according to the invention is iso-tridecyl stearate, iso-tridecyl palmitate, octyldodecyl stearate, octyldodecyl palmitate, 2-propylheptyl stearate, 2-propylheptyl palmitate or a mixture of two or more of the aforementioned esters.

Preferably, the elastomer comprised in the composition of the invention has a molecular weight in the range of between 100000 Dalton and 5000000 Dalton.

In a preferred embodiment of the composition according to the invention the elastomer is selected from the group consisting of a butadiene polymer, an acrylonitrile-butadiene copolymer, an isoprene polymer, a polyamide, a nitrile butadiene rubber (NBR), a hydrogenated nitrile butadiene rubber (HNBR), a chloroprene rubber (CR), an FKM elastomer, an ethylene-propylene-diene monomer rubber (EPDM), a butadiene rubber (BR), a natural rubber (NR), a styrene-butadiene rubber (SBR), a diene rubber, a fluorocarbon elastomer, an acrylic elastomer, an ethylene acrylic elastomer, a silicone rubber, a polyurethane elastomer, an ethylene propylene elastomer and mixtures thereof.

Non-limiting examples of a diene rubber include natural rubber (NR), styrene-butadiene rubber (SBR), butadiene rubber (BR), ethylene-propylene-diene monomer rubber (EPDM), isoprene rubber (IR), nitrile rubber (NBR), butyl rubber (IIR), and chlorobutyl rubber (CIIR). The diene rubbers are well known in the art, and are commercially available, along with suitable curing agents and systems, from a variety of sources.

In preferred embodiments, diene rubbers of the invention can be cured with sulfur vulcanization agents. In an exemplary recipe, about 0.4-4 phr of sulfur are used together with about 0.5-2 phr of a sulfur accelerator to provide systems that can cure in a matter of minutes. Normally, the cure is further enhanced by the action of metal salt such as a zinc carboxylate, which is conveniently provided from ZnO and a fatty acid such as stearic acid included in the rubber formulation. A wide variety of accelerators is known. Non-limiting examples include benzothiazoles, benzothiazolesulfenamides, dithiocarbamates, and amines such as diphenylguanidine and di-o-tolylguanidine (DOTG). Sulfur is provided in the form of elemental sulfur, a sulfur donor such as tetramethylthiuram disulfide (TMTD) or dithiodimorpholine (DTDM), or a combination of elemental sulfur and sulfur donor.

In other preferred embodiments, phenolic curatives are used to crosslink a diene rubber. These crosslinking agents are based on phenol, usually substituted with —CH₂X, where X is a halogen. The curative contains proton and electron acceptors in a proper steric relationship to establish a crosslink. In still other embodiments, bismaleimides such as m-phenylenebismaleimide can be used as crosslinkers. A free radical source such as an organic peroxide may be used to initiate crosslinking by the bismaleimides. In various preferred embodiments, organic peroxides can be used to crosslink or cure diene rubbers, as well as other elastomers. They are generally useful for isoprene rubbers and butadiene rubbers, but are not preferred for butyl rubber.

Acrylic elastomers have the ASTM designation ACM for polymers of ethyl acrylate and other acrylates, and ANM for copolymers of ethyl or other acrylates with acrylonitrile. Acrylic elastomers can be prepared by polymerizing so-called backbone monomers with optionally a minor amount of cure site monomer. The backbone monomers are preferably selected from among ethyl acrylate and other acrylic monomers. Other preferred acrylic acrylate monomers to be co-polymerized together with ethyl acrylate to make acrylic elastomers include n-butyl acrylate, 2-methoxyethyl acrylate, and 2-ethoxyethyl acrylate.

The acrylic elastomers may contain from about 1 to about 5 mole % or weight % of cure site monomers to introduce reactive sites for subsequent crosslinking. Among common cure site monomers are those that contain unsaturated carbon bonds and their side chain and those that contain a carbon chlorine bond in the side chain. Acrylic elastomers (ACM) are commercially available, such as from Zeon under the Nypol® and Hytemp® tradenames, and from Unimatec under the Noxtite® tradename.

Ethylene acrylic elastomers have the ASTM designation AEM. They are typically based on copolymers of ethylene and acrylate monomers, with a minor amount of cure site monomer, usually containing a carboxyl group in the side chain. Curing agents or crosslinking agents may then be used to cure or vulcanize the ethylene acrylic elastomer by reacting with the functional group in the cure site monomer. Two main classes of curing of vulcanization agents for use with such elastomers include the class of diamines and the class of peroxides. Diamines have the advantage that they cure slower but can be used at higher temperatures without scorch from too fast a cure. Also mixtures of curing agents may be used, as is known to those of skill in the art, to obtain a desirable cure rate in light of the temperature conditions of the reaction. Ethylene acrylic elastomers are commercially available, for example from DuPont under the Vamac® tradename. For example, Vamac G is used to designate a line diamine cured elastomers, while Vamac D represents a line of peroxide cured elastomers.

Silicone rubbers are well known. They are based on polysiloxanes that can generally be crosslinked by the action of a number of curing agents or curing systems to form cured elastomers. Suitable curing agents include silanes, peroxides, and platinum catalysts. Commercial sources of silicone rubbers and curing systems include Dow Corning and General Electric.

Polyurethane elastomers preferably contain repeating units containing urethane and/or urea groups. In some embodiments, the uncured elastomers are provided as gums or resins that can be crosslinked by the action of peroxides or other crosslinking agents such as isocyanates. Suitable polyurethane elastomers and curing systems are commercially available from such suppliers as BASF and Unimatec.

Fluorocarbon elastomers are curable compositions based on fluorine-containing polymers. Various types of fluoroelastomers may be used. One classification of fluoroelastomers is given in ASTM-D 1418, “Standard practice for rubber and rubber latices-nomenclature”. The designation FKM is given for fluoro-rubbers that utilize vinylidene fluoride as a co-monomer. Several varieties of FKM fluoroelastomers are commercially available. A first variety may be chemically described as a copolymer of hexafluoropropylene and vinylidene fluoride. These FKM elastomers tend to have an advantageous combination of overall properties. Some commercial embodiments are available with about 66% by weight fluorine. Another type of FKM elastomer may be chemically described as a terpolymer of tetrafluoroethylene, hexafluoropropylene, and vinylidene fluoride. Such elastomers tend to have high heat resistance and good resistance to aromatic solvents. They are commercially available with, for example 68-69.5% by weight fluorine. Another FKM elastomer is chemically described as a terpolymer of tetrafluoroethylene, a fluorinated vinyl ether, and vinylidene fluoride. Such elastomers tend to have improved low temperature performance. They are available with 62-68% by weight fluorine. A fourth type of FKM elastomer is described as a terpolymer of tetrafluoroethylene, propylene, and vinylidene fluoride. Such FKM elastomers tend to have improved base resistance. Some commercial embodiments contain about 67% weight fluorine. A fifth type of FKM elastomer may be described as a pentapolymer of tetrafluoroethylene, hexafluoropropylene, ethylene, a fluorinated vinyl ether and vinylidene fluoride. Such elastomers typically have improved base resistance and have improved low temperature performance.

Another category of fluorocarbon elastomers is designated as FFKM. These elastomers may be designated as perfluoroelastomers because the polymers are completely fluorinated and contain no carbon hydrogen bond. As a group, the FFKM fluoroelastomers tend to have superior fluid resistance. They were originally introduced by DuPont under the Kalrez® trade name. Additional suppliers include Daikin and Ausimont.

A third category of fluorocarbon elastomer is designated as FTPM. Typical of this category are the copolymers of propylene and tetrafluoroethylene. The category is characterized by a high resistance to basic materials such as amines.

Preferred fluorocarbon elastomers include commercially available copolymers of one or more fluorine containing monomers, chiefly vinylidene fluoride (VDF), hexafluoropropylene (HFP), tetrafluoroethylene (TFE), and perfluorovinyl ethers (PFVE). Preferred PFVE include those with a C1-8 perfluoroalkyl group, preferably perfluoroalkyl groups with 1 to 6 carbons, and particularly perfluoromethyl vinyl ether and perfluoropropyl vinyl ether. In addition, the copolymers may also contain repeating units derived from olefins such as ethylene (Et) and propylene (Pr). The copolymers may also contain relatively minor amounts of cure site monomers (CSM), discussed further below. Preferred copolymer fluorocarbon elastomers include VDF/HFP, VDF/HFP/CSM, VDF/HFP/TFE, VDF/HFP/TFE/CSM, VDF/PFVE/TFE/CSM, TFE/Pr, TFE/Pr/VDF, TFE/Et/PFVE/VDF/CSM, TFE/Et/PFVE/CSM and TFE/PFVE/CSM. The elastomer designation gives the monomers from which the elastomer gums are synthesized. In various embodiments, the elastomer gums have viscosities that give a Mooney viscosity in the range generally of 15-160 (ML1+10, large rotor at 121° C.), which can be selected for a combination of flow and physical properties. Elastomer suppliers include Dyneon (3M), Asahi Glass Fluoropolymers, Solvay/Ausimont, Dupont, and Daikin.

In a preferred embodiment of the composition of the invention the composition further comprises
(c) a filler selected from the group consisting of calcium carbonate, dolomite, kaolinite, carbon, zeolite, graphite, mica, borosilicate, silicon dioxide, cellulose, silicic acid, aluminiumhydroxide, magnesiumhydroxide, magnesiumoxide, zincoxide and calciumoxide, chalk, kaolin, quartz powder, barite, a metal powder, hydrated alumina, cement, talc, diatomaceous earth, sawdust, wood chips and a mixture of at least two of these fillers.

It is preferred with respect to the filler that said filler has a mean particle size of between 1 nm to 1000 nm or between 1 micrometre and 500 micrometres. Filler particles can be obtained for example by micronization.

In a further preferred embodiment of the composition according to the invention said filler is preferably comprised in said composition in an amount of 5-300 parts per hundred parts of elastomer by weight (phr), preferably in an amount of 10-200 phr, and most preferably in an amount of 15-150 phr.

It is also preferred that the ester is comprised in said composition of the invention in an amount of 5-300 parts per hundred parts of elastomer by weight (phr) and preferably in an amount of 10-200 phr and most preferably in an amount of 15-150 phr.

The composition of the invention may in a preferred embodiment also further comprise (c) a thermoplastic for example a thermoplastic selected from the group consisting of polypropylene, polyethylene, polystyrene, acrylonitrile-butadiene-styrene (ABS), an allyl resin, ethylene vinyl alcohol, a fluoroplastic, a polyacetal, a polyacrylate, a polyacrylonitrile, a polyamide, a polyimide, a polycarbonate, a polyester, a polyethylene oxide, a polypropylene oxide, polyethylene glycol, polypropylene glycol, polyvinylidene chloride and a mixture of the at least two of the aforementioned thermoplastic.

In most preferred embodiments the composition of the invention is in the form of a seal, gasket, O-ring or a hose.

In a further aspect the invention relates to the use of an ester of the invention as defined herein as plasticizer in an elastomer.

In a preferred embodiment of the use according to the invention said elastomer comprises a filler as defined herein.

The plasticizer of the invention can be used in any type of elastomer. Preferably, however, the elastomer is an elastomer as described herein in the context of the preferred embodiments.

It is preferred that the ester of the invention is derived to 100% from renewable resources. Thus, in a preferred embodiment of the use of the invention said alcohol in (i) and/or said fatty acid in (ii) are derived to 100% from renewable resources. Furthermore, it is also preferred that in the composition of the invention said alcohol in (i) and/or said fatty acid in (ii) are derived to 100% from renewable resources.

Various modifications and variations of the invention will be apparent to those skilled in the art without departing from the scope of the invention. Although the invention has been described in connection with specific preferred embodiments, it should be understood that the invention as claimed should not be unduly limited to such specific embodiments.

The following examples are merely illustrative of the present invention and should not be construed to limit the scope of the invention as indicated by the appended claims in any way.

### EXAMPLES

### Example 1

### Ester Production

The esters of the invention can be obtained utilizing conventional esterification procedures. This generally involves reacting the carboxylic acid with the alcohol at an elevated temperature (for example between about 150° C. to about 180° C.) while removing water. Esterification catalysts may be used but are not necessary for the reaction. The ester may be further purified by distillation and/or filtration.

For the plasticizers used in the examples below the yield was 99%, based on the fatty acid weighed out.

### Example 2

### Production of an Elastomer

### Without Curing Agents

100 phr of EPDM (Keltan Eco 5508, Lanxess) were milled on a roller at a temperature of 120/125° C. until a sheet formed. Then, 70 phr of filler (Corax N550, Orion Engineered Carbons), predispersed in 70 phr of plasticizer (e.g. 2-Octyldodecyl stearate/palmitate based on technical stearic/palmitic acid (mixture comprising stearic and palmitic acid with a stearic acid content of at least 45%)), were added in portions to obtain a homogeneous black sheet.

### With Curing Agents

100 phr of EPDM (Keltan Eco 5508, Lanxess) were milled on a roller at a temperature of 120/125° C. until a sheet formed. Then, a mixture of the following components was added in portions to obtain a homogeneous black sheet:

95 phr Corax N550, Orion Engineered Carbons; 1 phr LOXIOL® G 20, Emery

Oleochemicals; 5 phr Silox Active FF, Silox; 1.4 phr MBTS 75 GA F140, Mixland; 3.5 phr ZDPT 50 GA F500, Mixland; 0.7 phr ZBEC 70 GA F100, Mixland; 1.25 phr S 80 GA F500, Mixland; 0.5 phr Alchem REC, Alchem; 70 phr plasticizer (e.g. 2-octyldodecyl stearate/palmitate based on technical stearic/palmitic acid (mixture comprising stearic and palmitic acid with a stearic acid content of at least 45%))

### Pressed Sheets

For the preparation of pressed sheets, the rolled sheets were pressed for 10 min at 300 bar and 130° C. and then cooled to 40° C. during 5 min at 300 bar in a press by Servitec (Polystat 200 T).

### Example 3

### Properties of the Elastomer Comprising the Plasticizer

TABLE 1
Shore A hardness according to DIN ISO 7619 of pressed sheets with different
plasticizers:

| | Composition/No. | | | | | |
|---|---|---|---|---|---|---|
| | 1 | 2 | 3 | 4 | 5 | 6 |
| EPDM | 100 phr | 100 phr | 100 phr | 100 phr | 100 phr | 100 phr |
| phr | | | | | | |
| Filler | 70 phr | 70 phr | 70 phr | 110 phr | 110 phr | 110 phr |
| Paraffinic oil (Tudalen 3909) | 70 phr | | | 70 phr | | |
| iso-tridecyl stearate/palmitate | | 70 phr | | | 70 phr | |
| based on technical | | | | | | |
| stearic/palmitic acid (*) | | | | | | |
| 2-octyldodecyl | | | 70 phr | | | 70 phr |
| stearate/palmitate based on | | | | | | |
| technical stearic/palmitic acid | | | | | | |
| (*) | | | | | | |
| SHORE A hardness | 39.2 | 31.6 | 30.2 | 59.4 | 58.7 | 55.2 |

TABLE 2
Volatility determination of the pressed plates after
storage at 100° C. for 4 weeks:

| | No. | | | | | |
|---|---|---|---|---|---|---|
| Composition | 1 | | 2 | | 3 | |
| EPDM (Keltan ECO 5508) | 100 | phr | 100 | phr | 100 | phr |
| Filler (Corax N550 = carbon black) | 95 | phr | 95 | phr | 95 | phr |
| Stearic acid LOXIOL ® G 20 | 1.00 | phr | 1.00 | phr | 1.00 | phr |
| Zinc oxid (Silox Active FF) | 5.00 | phr | 5.00 | phr | 5.00 | phr |
| MBTS 75 GA F140 (2,2′- | 1.40 | phr | 1.40 | phr | 1.40 | phr |
| Dibenzothiazyldisulfide | | | | | | |
| in a polymeric binder) | | | | | | |
| ZDPT 50 GA F500 | 3.50 | phr | 3.50 | phr | 3.50 | phr |
| (Zinc-O,O-diisopropyldi- | | | | | | |
| thiophosphate in a polymeric binder) | | | | | | |
| ZBEC 70 GA F100 (Zinc | 0.70 | phr | 0.70 | phr | 0.70 | phr |
| dibenzyldithiocarbamate | | | | | | |
| in a polymeric binder) | | | | | | |
| S 80 GA F500 (Sulphur) | 1.25 | phr | 1.25 | phr | 1.25 | phr |
| Alchem Rec [N-Phenyl-N | 0.50 | phr | 0.50 | phr | 0.50 | phr |
| (Trichloromethyl sulfenyl) | | | | | | |
| benzene sulphonamide] | | | | | | |
| Paraffinic oil (Tudalen 3909) | 70 | phr | | | | |
| iso-tridecyl stearate/palmitate | | | 70 | phr | | |
| based on technical | | | | | | |
| stearic/palmitic acid (*) | | | | | | |
| 2-octyldodecyl stearate/palmitate | | | | | 70 | phr |
| based on technical stearic/ | | | | | | |
| palmitic acid (*) | | | | | | |

| | | | |
|---|---|---|---|
| Amount of volatile components | 1.7% | 1.7% | 1.1% |
| leaving the sample after storing | | | |
| the pressed plates (sample weight | | | |
| at the beginning about 5 g) for | | | |
| four weeks at 100° C. | | | |

(*) technical stearic/palmitic acid = mixture comprising stearic and palmitic acid with a stearic acid content of at least 45%.

As shown above, it was found that the plasticizer of the invention, which in this example was an ester based on renewable raw materials, gave excellent plasticizing properties for various elastomers including EPDM. Similar results are expected for other elastomers such as SBR, BR, NBR, FKM, HNBR and NR.

It could further be shown, that the plasticizer exhibits a low volatility and migration behaviour which is beneficial to guarantee a long working life of the final elastomer articles that can be obtained from the elastomer for example by extrusion.

Furthermore, for the ester also a good compatibility with the respective elastomer matrix and various kinds of fillers like carbon black, chalk, etc. could be demonstrated.

1. A composition comprising
(a) an ester obtainable by reacting
(i) an unsaturated branched or saturated branched aliphatic C8-C28 alcohol; with
(ii) an unsaturated linear or saturated linear C12-C22 fatty acid;
and
(b) an elastomer.

2. The composition according to claim 1, wherein the alcohol in (i) is a saturated branched C10-C24 alcohol.

3. The composition according to claim 2, wherein the alcohol in (i) is a saturated branched C13-C20 alcohol.

4. The composition according to claim 1, wherein the fatty acid in (ii) is 20 a linear saturated fatty acid.

5. The composition according to claim 1, wherein the elastomer has a molecular weight in the range of between 100000 Dalton and 5000000 Dalton.

6. The composition according to claim 1, wherein the elastomer is selected from the group consisting of a butadiene polymer, an acrylonitrile-butadiene copolymer, an isoprene polymer, a polyamide, a nitrile butadiene rubber (NBR), a hydrogenated nitrile butadiene rubber (HNBR), a chloroprene rubber (CR), an FKM elastomer, an ethylene-propylene-diene monomer rubber (EPDM), a butadiene rubber (BR), a natural rubber (NR), a styrene-butadiene rubber (SBR), a diene rubber, a fluorocarbon elastomer, an acrylic elastomer, an ethylene acrylic elastomer, a silicone rubber, a polyurethane elastomer, an ethylene propylene elastomer and mixtures thereof.

7. The composition according to claim 1, wherein the composition further comprises
(c) a filler selected from the group consisting of calcium carbonate, dolomite, kaolinite, carbon, zeolite, graphite, mica, borosilicate, silicon dioxide, cellulose, silicic acid, aluminiumhydroxide, magnesiumhydroxide, magnesiumoxide, zincoxide and calciumoxide, chalk, kaolin, quartz powder, barite, a metal powder, hydrated alumina, cement, talc, diatomaceous earth, sawdust, wood chips and a mixture of at least two of these fillers.

8. The composition according to claim 7, wherein said filler has a mean particle size of between 1 nm to 1000 nm or between 1 micrometer and 500 micrometers.

9. The composition according to claim 8, wherein said filler is comprised in said composition in an amount of 5-300 parts per hundred parts of elastomer by weight (phr) and preferably in an amount of 10-200 phr and most preferably in an amount of 15-150 phr.

10. The composition according to claim 8, wherein the ester is comprised in said composition in an amount of 5-300 parts per hundred parts of elastomer by weight (phr) and preferably in an amount of 10-200 phr and most preferably in an amount of 15-150 phr.

11. A use of an ester as defined in claim 8 as plasticizer in an elastomer.

12. The use according to claim 11, wherein said elastomer comprises a filler as defined in claim 7.

13. The use according to claim 11, wherein said elastomer is an elastomer as defined in claim 5.

14. The use according to claim 11, wherein said alcohol in (i) and/or said fatty acid in (ii) are derived to 100% from renewable resources.
